(19) United States
(12) Patent Application Publication
(10) Pub. No.: US 2026/0313664 A1
(43) Pub. Date: Oct. 8, 2026

(54) METHODS FOR BEAM MANAGEMENT AND TRANSMISSION ENHANCEMENT IN SIDELINK COMMUNICATION

(71) Applicant: MEDIATEK SINGAPORE PTE. LTD., Singapore (SG)

(72) Inventors: Chenmeng LI, Beijing (CN); Jing-Wei CHEN, Hsinchu City (TW); Tao CHEN, Beijing (CN); Ming-Yuan CHENG, Hsinchu City (TW); Junqiang CHENG, Beijing (CN)

(73) Assignee: MEDIATEK SINGAPORE PTE. LTD., Singapore (SG)

(21) Appl. No.: 19/474,456

(22) PCT Filed: Jul. 5, 2024
(86) PCT No.: PCT/CN2024/103746

§ 371 Date: Oct. 10, 2025

(30) Foreign Application Priority Data
Aug. 11, 2023 (WO) PCT/CN2023/112656

(51) Int. Cl. H04W 72/25; H04B 7/06

(52) U.S. Cl. CPC H04W 72/25; H04B 7/06952

(57) ABSTRACT

Various solutions for beam management and transmission enhancement in sidelink (SL) communication are described. An apparatus may initiate an initial beam pairing (IBP) procedure for an SL communication with a peer apparatus, by transmitting a discovery signaling on one or more logical beams or spatial beams. The one or more logical beams are associated with the one or more spatial beams. Then, the apparatus may receive or transmit a direct communication request signaling from or to the peer apparatus on a first spatial beam among the one or more spatial beams. Also, the apparatus may transmit or receive a direct communication response signaling to or from the peer apparatus on the first spatial beam.

### CROSS REFERENCE TO RELATED PATENT APPLICATION(S)

The present disclosure is part of a non-provisional application claiming the priority benefit of PCT Application No. PCT/CN2023/112656, filed 11 Aug. 2023, the content of which herein being incorporated by reference in its entirety.

### TECHNICAL FIELD

The present disclosure is generally related to mobile communications and, more particularly, to beam management and transmission enhancement in sidelink (SL) communication.

### BACKGROUND

Unless otherwise indicated herein, approaches described in this section are not prior art to the claims listed below and are not admitted as prior art by inclusion in this section.

Cellular based vehicle-to-everything (V2X) (e.g., long-term evolution (LTE) V2X or new radio (NR) V2X) is a radio access technology developed by the 3^{rd} generation partnership project (3GPP) to support advanced vehicular applications. In V2X, a direct radio link (also called a sidelink) may be established between two user equipments (UEs) (e.g., mounted on vehicles). The sidelink may operate under the control of a cellular network (e.g., for radio resource allocation) when the UEs are within the coverage of the cellular network. Alternatively, the sidelink may operate independently, e.g., when no cellular network is present or reachable. In particular, sidelink communication is performed via a direct communication interface called PC5 interface.

When implementing mobile communication in a higher frequency range (e.g., frequency range 2 (FR2), typically ranges from 24.25 giga-hertz (GHz) to 71.0 GHZ), impacts of signal and coverage degradations need to be mitigated with certain techniques such as beamforming and beam management. However, the current framework of SL communication in 4^{th} generation (4G) LTE or 5^{th} generation (5G) new radio (NR) does not support beam-related functionalities. With the lack of the beam-related functionalities, the utilization of the high frequency spectrum in SL communication will face the issue of how to maintain good connection quality.

Furthermore, to meet the increased demands of wireless data traffic, the utilization of unlicensed spectrum has become an option to improve the capacity of future wireless communication systems, including SL communication in 4G LTE or 5G NR. In unlicensed spectrum, a guard band (GB) is provided between adjacent sub-channels to prevent interference and ensure efficient and interference-free communication. Generally, the GB is left unused or unallocated, but due to the demand for more available bandwidth, there are discussions in 3GPP about allowing the use of the GB for SL communication. However, there is still an issue regarding under what conditions can the GB be used for SL communication without exacerbating interference in unlicensed spectrum. Another issue with the utilization of unlicensed spectrum is that, certain mechanisms applied in SL communication may result in signals with high peak-to-average power ratio (PAPR), which cause excessive intermodulation distortion of the power amplifier at the transmitter side and lead to bad signal detection at the receiver side.

Therefore, there is a need to provide solutions for the aforementioned issues with SL communication.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to SL communication.

In one aspect, a method may involve an apparatus initiating an initial beam pairing (IBP) procedure for an SL communication (e.g., in FR2) with a peer apparatus, by transmitting a discovery signaling on one or more logical beams or spatial beams. The one or more logical beams are associated with the one or more spatial beams. The method may also involve the apparatus receiving or transmitting a direct communication request signaling from or to the peer apparatus on a first spatial beam among the one or more spatial beams. The method may further involve the apparatus transmitting or receiving a direct communication response signaling to or from the peer apparatus on the first spatial beam.

In one aspect, a method may involve an apparatus responding to an IBP procedure for an SL communication (e.g., in FR2) with a peer apparatus, by receiving a discovery signaling on one or more logical beams or spatial beams. The one or more logical beams are associated with the one or more spatial beams. The method may also involve the apparatus transmitting or receiving a direct communication request signaling to or from the peer apparatus on a first spatial beam among the one or more spatial beams. The method may further involve the apparatus receiving or transmitting a direct communication response signaling from or to the peer apparatus on the first spatial beam.

In one aspect, a method may involve an apparatus determining that at least one of a CRB-based transmission and a signal repetition in frequency domain is applied for an SL-U communication with a peer apparatus. The method may also involve the apparatus performing the SL-U communication with the peer apparatus responsive to the determining.

It is noteworthy that, although description provided herein may be in the context of certain radio access technologies, networks and network topologies such as LTE, LTE-Advanced, LTE-Advanced Pro, 5G, NR, Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of beam management in accordance with an implementation of the present disclosure.

FIG. 3 is a diagram depicting an example scenario of an IBP procedure based on discovery model A in accordance with an implementation of the present disclosure.

FIG. 4 is a diagram depicting an example scenario of an IBP procedure based on discovery model B in accordance with an implementation of the present disclosure.

FIG. 5 is a block diagram of an example communication system in accordance with an implementation of the present disclosure.

FIG. 6 is a flowchart of an example process under schemes in accordance with an implementation of the present disclosure.

FIG. 7 is a flowchart of an example process under schemes in accordance with an implementation of the present disclosure.

FIG. 8 is a flowchart of an example process under schemes in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to beam management and transmission enhancement in SL communication. According to the present disclosure, a number of possible solutions may be implemented separately or jointly. That is, although these possible solutions may be described below separately, two or more of these possible solutions may be implemented in one combination or another.

Beam management is a critical technique in wireless communication system. Typically, beam management includes a set of procedures to establish and retain an optimal beam pair for good connectivity which consists of a transmit beam and a corresponding receive beam. This is important for wireless communication in FR2, as the utilization of the high frequency spectrum requires the use of beamforming and beam management techniques to ensure good connection quality. Beam management can effectively increase the coverage area of a signal, especially important for wireless communication in FR2, since each beam sacrifices the coverage range of the signal to increase the coverage distance of the signal and beam sweeping is applied during the procedure. However, the current framework of SL communication in 4G LTE or 5G NR does not support beam management functionality.

In addition, when implementing SL communication in unlicensed spectrum, an option of using the GB for SL communication is being discussed in 3GPP. However, there is still an issue regarding under what conditions can the GB be used for SL communication without exacerbating interference in unlicensed spectrum. Another issue with the utilization of unlicensed spectrum is that, certain mechanism, such as signal repetition in frequency domain, may result in signals with high PAPR, which cause excessive intermodulation distortion of the power amplifier at the transmitter side and lead to bad signal detection at the receiver side. Signal/sequence repetition in frequency domain may be used in some cases. In one example, to meet the occupied channel bandwidth (OCB) requirement for transmission on an unlicensed band, a UE may determine to apply signal repetition in frequency domain for SL communication with another UE. In another example, to achieve a diversity gain or to increase the transmission power when there is a power spectrum density (PSD) limitation, the UE may be configured to apply signal sequence repetition in frequency domain.

In view of the above, the present disclosure proposes a number of schemes pertaining to beam management and transmission enhancement in SL communication. FIG. 1 illustrates an example scenario 100 of a communication environment in which various solutions and schemes in accordance with the present disclosure may be implemented. Scenario 100 involves two UEs in wireless communication with each other for direct communication (i.e., SL communication). In such communication environment, the transmitting (Tx) UE and the receiving (Rx) UE may implement various schemes pertaining to beam management and transmission enhancement in SL communication in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under certain schemes of the present disclosure, an IBP procedure for SL communication (e.g., in FR2) may be implemented based on a discovery procedure (e.g., the 5G proximity services (ProSe) Direct Discovery procedure). Specifically, a UE may initiate an IBP procedure for an SL communication with a peer UE, by transmitting a discovery signaling on one or more logical beams or spatial beams, wherein the one or more logical beams are associated with the one or more spatial beams. In one example, the initiating UE may be referred to as an announcing UE and the discovery signaling may include a Discovery Announcement message, if the mode of discovery is model A. In another example, the initiating UE may be referred to as a discoverer UE and the discovery signaling may include a Discovery Solicitation message, if the mode of discovery is model B. Then, the UE may receive (in the case of discovery model A) or transmit (in the case of discovery model B) a direct communication request signaling (e.g., a Direct Communication Request message) from or to the peer UE on a first spatial beam among the one or more spatial beams. Subsequently, the UE may transmit (in the case of discovery model A) or receive (in the case of discovery model B) a direct communication response signaling (e.g., a Direct Communication Accept/Reject message) to or from the peer UE on the first spatial beam. Accordingly, after the peer UE receives and decodes the Direct Communication Accept message from the UE, the IBP procedure is successfully completed and these two UEs may perform SL communication with each other via the logical/spatial beam pair.

Specifically, a logical beam may refer to a transmitting/receiving beam of a UE, which is associated with a beam identifier (ID) assigned by the UE, while a spatial beam may refer to a transmitting/receiving beam of a UE in spatial domain (e.g., different spatial beams towards different directions). In some implementations, each UE may maintain a mapping between logical beams and spatial beams. The same spatial beams may be mapped to one or multiple logical beams, and a logical beam may be mapped to one or multiple spatial beams. The mapping rules may change after a timer expires and/or other regulations due to UE's rotation, movement, and/or other UE behaviors. The direction of a logical beam that mapped to a spatial beam is the same as the direction of the mapped spatial beam, or is within or contains the direction coverage of the mapped spatial beam.

In some implementations, the UE may repeatedly transmit the discovery signaling on the same logical/spatial beam, while the peer UE may monitor the discovery signaling on different logical/spatial beams in a beam sweeping manner. Alternatively, the UE may repeatedly transmit the discovery signaling on different logical/spatial beams in a beam sweeping manner, while the peer UE may monitor the discovery signaling on the same logical/spatial beam.

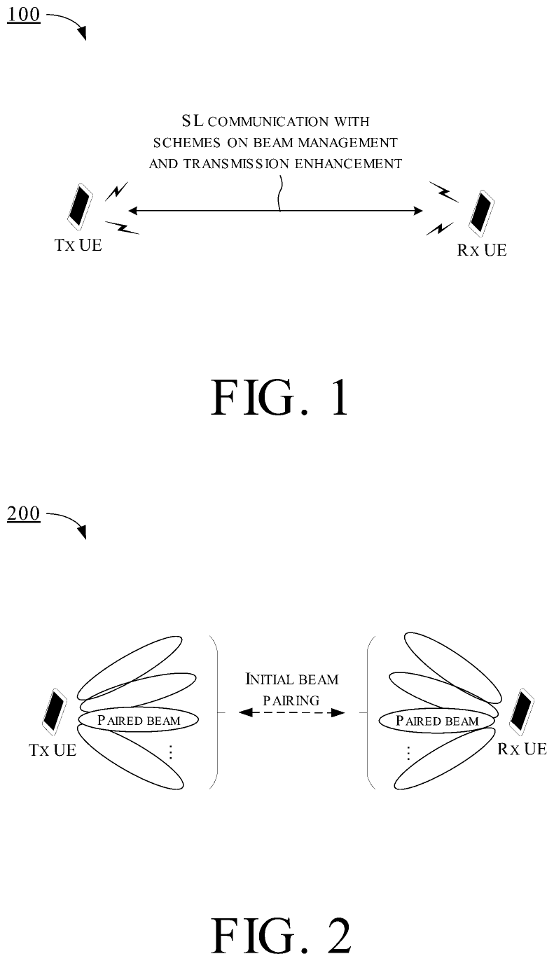

FIG. 2 illustrates an example scenario 200 of beam management in accordance with an implementation of the present disclosure. Scenario 200 involves two UEs in wireless communication with each other for direct communication (i.e., SL communication), by engaging an IBP procedure to pair up a transmitting beam of the Tx UE and a receiving beam of the Rx UE. Specifically, the IBP procedure may be implemented based on a discovery procedure (e.g., the 5G ProSe Direct Discovery procedure) of mode A or mode B, as described below.

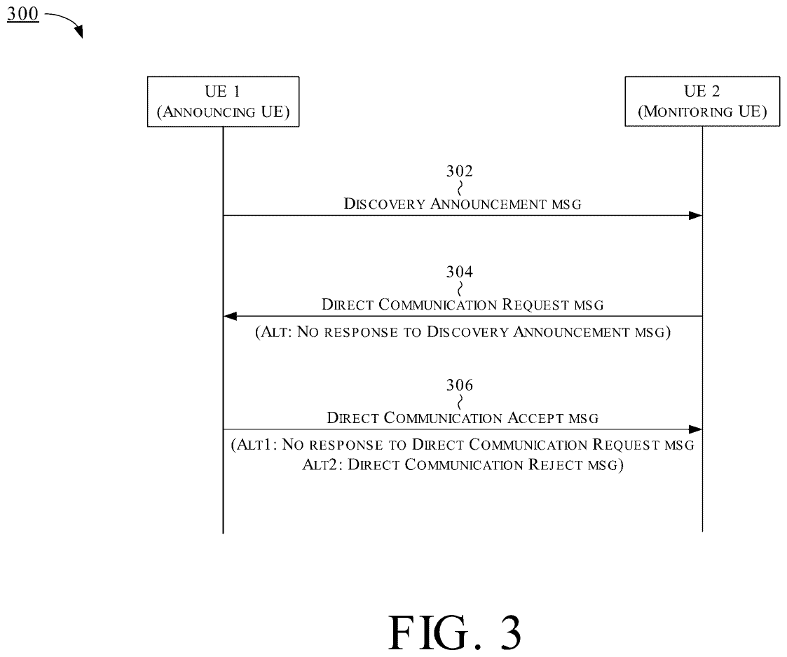

FIG. 3 illustrates an example scenario 300 of an IBP procedure based on discovery model A in accordance with an implementation of the present disclosure. Scenario 300 involves two UEs in an IBP procedure for SL communication (e.g., in FR2), wherein the initiating UE (i.e., UE 1) of the IBP procedure is the Announcing UE of Discovery Model A, and the peer UE (i.e., UE 2) of the IBP procedure is the Monitoring UE of Discovery Model A. In step 302, UE 1 repeatedly transmits the Discovery Announcement message on the same logical or spatial beam, and UE 2 keeps monitoring the Discovery Announcement message on the same or different logical or spatial beams. In step 304, when UE 2 receives and decodes a Discovery Announcement message and decides to establish a link with UE 1, UE 2 transmits a Direct Communication Request message on the same spatial beam where the Announcement message is received and decoded. In step 306, when UE 1 receives and decodes the Direct Communication Request message from UE 2 and decides to accept it, an initial beam pair between UE 1 and UE 2 is established and UE 1 transmits a Direct Communication Accept message to UE 2 on the same spatial beam where the Direct Communication Request message is received and decoded. Meanwhile, when UE 2 receives and decodes the Direct Communication Accept message from UE 1, the IBP procedure is successfully completed and the these two UEs may communicate via the logical or spatial beam pair.

Alternatively, if UE 1 receives and decodes a Direct Communication Request message from UE 2 and decides to reject it, UE 1 may transmit a Direct Communication Reject message to UE 2 on the same spatial beam where the Direct Communication Request message is received and decoded. If UE 2 receives and decodes the Direct Communication Reject message from UE 1 (or no response, e.g., Direct Communication Accept/Reject message, is received from UE 1), both the IBP procedure and the link establishment procedure are determined as failed, and optionally, UE 1 may restart the IBP procedure.

Alternatively, for the case of no response is received from the opposite UE (e.g., no Direct Communication Request message from UE 2 is received and decoded by UE 1, or no Direct Communication Accept/Reject message from UE 1 is received and decoded by UE 2, etc.), if the max retransmission time of the Discovery Announcement message or Direct Communication Request message on the same logical or spatial beam is reached and/or the timer of transmitting the Discovery Announcement message or the Direct Communication Request message on the same logical or spatial beam expires, it is up to UE's implementation to repeatedly transmit the Discovery Announcement message or the Direct Communication Request message on other logical or spatial beams, till the max retransmission time of the Discovery Announcement message or the Direct Communication Request message on all the other logical or spatial beams is reached and/or the timer of transmitting the Discovery Announcement message or the Direct Communication Request message on all the other logical or spatial beams expires.

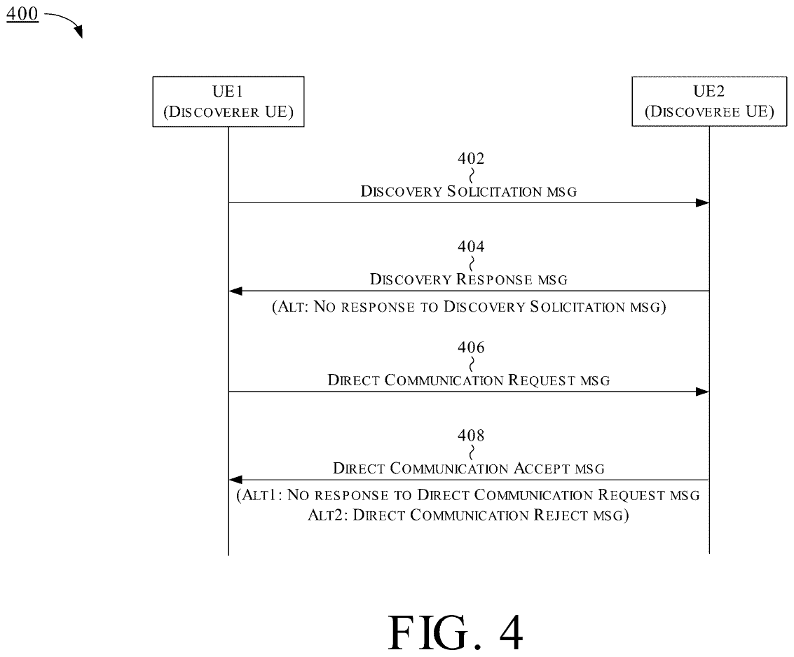

FIG. 4 illustrates an example scenario 400 of an IBP procedure based on discovery model B in accordance with an implementation of the present disclosure. Scenario 400 involves two UEs in an IBP procedure for SL communication (e.g., in FR2), wherein the initiating UE (i.e., UE 1) of the IBP procedure is the Discoverer UE of Discovery Model B, and the peer UE (i.e., UE 2) of the IBP procedure is the Discoveree UE of Discovery Model B. In step 402, UE 1 repeatedly transmits the Discovery Solicitation message on the same logical or spatial beam, and UE 2 keeps monitoring the Discovery Solicitation message on the same or different logical or spatial beams. In step 404, when UE 2 receives and decodes the Discovery Solicitation message from UE 1 and decides to respond to UE 1, UE 2 transmits a Discovery Response message on the same spatial beam where the Discovery Solicitation message is received and decoded. In step 406, when UE 1 receives and decodes the Discovery Response message from UE 2 and decides to accept it, an initial beam pair between UE 1 and UE 2 is established and UE 1 transmits a Direct Communication Request message to UE 2 on the same spatial beam where the Discovery Response message is received and decoded. In step 408, when UE 2 receives and decodes the Direct Communication Request message from UE 1 and decides to accept it, UE 2 transmits a Direct Communication Accept message to UE 1 on the same spatial beam where the Direct Communication Request message is received and decoded. Meanwhile, when UE 1 receives and decodes the Direct Communication Accept message from UE 2, the IBP procedure is successfully completed and these two UEs may communicate via the logical or spatial beam pair.

Alternatively, if UE 2 receives and decodes the Direct Communication Request message from UE 1 and decides to reject it, UE 2 may transmit a Direct Communication Reject message to UE 1 on the same spatial beam where the Direct Communication Request message is received and decoded. If UE 1 receives and decodes the Direct Communication Reject message from UE 2 (or no response, e.g., Direct Communication Accept/Reject message, is received from UE 2), both the IBP procedure and the link establishment procedure are determined as failed, and optionally, UE 1 may restart the IBP procedure.

Alternatively, for the case of no response is received from the opposite UE (e.g., no Discovery Response message from UE 2 is received and decoded by UE 1, no Direct Communication Request message from UE 1 is received and decoded by UE 2, or no Direct Communication Accept/Reject message from UE 2 is received and decoded by UE 1, etc.), if the max retransmission time of the Discovery Solicitation message, the Discovery Response message, or the Direct Communication Request message on the same logical or spatial beam is reached and/or the timer of transmitting the Discovery Solicitation message, the Discovery Response message, or the Direct Communication Request message on the same logical or spatial beam expires, it is up to UE's implementation to repeatedly transmit the Discovery Solicitation message, the Discovery Response message, or the Direct Communication Request message on the other logical or spatial beams, till the max retransmission time of the Discovery Solicitation message, the Discovery Response message, or the Direct Communication Request message on all the other logical or spatial beams is reached and/or the timer of transmitting the Discovery Solicitation message, the Discovery Response message, or the Direct Communication Request message on all the other logical or spatial beams expires.

It should be noted that in the IBP procedure as described above, each Discovery message (i.e., the Discovery Announcement message, the Discovery Solicitation message, etc.) is not confined within the concept of an entire and/or exact Discovery message, and it may include signal(s) or channel(s) that shares the similar concept of the Discovery messages, or it may have the same function of the Discovery messages and/or segmented Discovery messages. For example, a Discovery message may be a signal (e.g., a channel state information-reference signal (CSI-RS), etc.) and the signal may be generated based on the Source/Destination ID of the Tx UE. The Rx UE may transmit a response to the Tx UE by an ACK/NACK and/or a message (e.g., a Direct Communication Request message, a Discovery Response message, etc.).

In some implementations, when a UE send a signaling/message during the IBP procedure, the timing and/or resource of the response of this signaling/message from a peer UE may be indicated by the UE or preconfigured (e.g., in 3GPP specifications). The timing(s) of the response from the peer UE may be a time delay in a granularity of slots and/or milliseconds. For example, in the IBP procedure based on discovery model A, candidate time resource(s) for the Direct Communication Request message may be indicated by the UE's Discovery Announcement message, or may be preconfigured. The candidate time resource(s) may be described as {n+T1, n+T2, . . . , n+Tr}, where n represents the slot timing of the first/last Discovery Announcement message among the repetitions or sweepings, and T1, T2, . . . , Tr represent the time delay in granularity of slots and/or milliseconds for the transmission of the Direct Communication Request message. The signaling/message sending UE may monitor the response from any peer UE at the candidate time resource(s) (e.g., denoted as n+T1, n+T2, . . . , n+Tr) using the same spatial beam as the signaling/message sending spatial beam. For the response UE, it may prioritize using the signaling/message receiving spatial beam to transmit the response. If the first transmission of the response failed, the response UE may retransmit the response on the same spatial beam or different spatial beam at candidate time resource(s) other than that indicated by signaling/message sending UE or preconfigured. It should be noted that the case of only one candidate time resource (e.g., n+T1) is also supported, where the response UE will send a response to the signaling/message sending UE on the best beam (e.g., the beam with the highest reference signal received power (RSRP), etc.).

In some implementations, a reference signal (RS) may be transmitted along with the Discovery Announcement message or Discovery Solicitation message on the same logical and spatial beam. For the case of the RS being a non-standalone RS (e.g., demodulation reference signal (DMRS)), the peer UE may measure, on the physical sidelink control channel (PSCCH) and/or physical sidelink shared channel (PSSCH), the RSRP of the DMRS within the Discovery Announcement message or Discovery Solicitation message. For the case of the RS being a standalone RS (e.g., CSI-RS), the peer UE may measure the CSI-RS transmitted with the Discovery Announcement message or Discovery Solicitation message. The CSI-RS may be indicated in the 2^{nd} sidelink control information (SCI) of the messages or may be preconfigured. Additionally, or optionally, if a standalone RS (e.g., CSI-RS, etc.) is used for the IBP procedure, the standalone RS may be generated based on the Source (i.e., Tx UE) Layer-2 or Layer-1 (i.e., physical layer (PHY)) (L2/L1) ID and/or Destination (i.e., Rx UE) L2/L1 ID. For example, the initiating UE of an IBP procedure may transmit repetitions of the standalone RS's repetition on the same spatial/logical beam or different spatial/logical beams. The receiving UE may transmit a feedback (e.g., acknowledgement or non-acknowledgement (ACK/NACK) and/or a response message back to the initiating UE at a preconfigured timing. After receiving the feedback and/or the response, the initiating UE may transmit a Discovery message to the receiving UE. It is noted that the standalone RS may use a dedicated/common resource pool and/or share the same resource pool with the Discovery messages.

In some implementations, standalone or non-standalone RS(s) (e.g., CSI-RS) may be used in a beam maintenance procedure. For example, the RS(s) may be generated based on a unique UE ID for beam management or other means. The unique UE ID may be a unique UE ID used for beam management (e.g., for beam maintenance), which is different from any other L1 IDs used to identify the UE during the discovery procedure, the link establishment procedure, or SL communication. For the case of standalone or non-standalone RSs, a specific frequency-division multiplexing (FDM) resource for different UEs may be preconfigured or chosen by the UE based on the unique UE ID for beam management. For the case of non-standalone RSs, the RSs may be transmitted on the same logical/spatial beam as that used for Tx data, and/or on a different logical/spatial beam as that used for Tx data.

Under certain schemes of the present disclosure, transmission enhancement on a CRB-based transmission and/or a signal repetition in frequency domain is supported for SL-U communication (e.g., in FR1 and/or FR2 unlicensed spectrums). Specifically, the CRB-based transmission is enhanced to allow the utilization of intra-cell guard band (GB) for PSSCH transmission, while the signal repetition in frequency domain is enhanced with a cyclic shift phase adjustment peak-to-average power ratio (PAPR) reduction method. Accordingly, by applying the schemes of the present disclosure, the GB may be used to increase the bandwidth for SL-U communication without exacerbating interference in unlicensed spectrum. Furthermore, by applying the schemes of the present disclosure, transmission with low PAPR may be realized to reduce intermodulation distortion of the power amplifier at the transmitter side and to provide better signal detection at the receiver side.

For the enhanced CRB-based transmission, the utilization of sub-channel including intra-cell GB physical resource blocks (PRBs) (i.e., sub-channel that is overlapped with intra-cell GB) for PSSCH transmission should meet the following conditions: (i) multi-channel access procedures on the respective listen-before-talk (LBT) channels (wrapped around the intra-cell GB) are cleared; and (ii) the used sub-channel(s) for PSSCH transmission occupy both of these two RB sets. In other words, the configured intra-cell GB PRBs between any two adjacent RB sets can be used only for PSSCH transmission, if (and only if), the UE has successfully performed channel access procedure in both adjacent RB sets, and the UE uses both of these RB sets for PSSCH transmission. Additionally, the UE may exclude candidate single-slot or candidate multi-slot resources with the sub-channel with the smallest index including resource blocks of the intra-cell GB PRBs (e.g., the PSSCH transmission should occupy at least one sub-channel with a lower index than that of the sub-channel(s) overlapped with intra-cell GB simultaneously for the corresponding PSCCH transmission).

For the enhanced signal repetition in frequency domain, a phase adjustment vector with different cyclic shift values may be applied for different repetitions of a signal in frequency domain, wherein the phase adjustment vector is generated based on an initial phase vector and the cyclic shift values are set to be different values. More specifically, the phase adjustment sequence has a frequency length of one sidelink synchronization signal block (S-SSB), or multiple S-SSBs after repetition. In the case of phase adjustment sequence having a length of one S-SSB, the different phase adjustment sequences used among repetitions may be generated by different initial parameters, which can be related to some (pre-) configuration, e.g., UE ID, sidelink ID (SLID), or repetition index. Alternatively, the different phase adjustment sequences used among repetitions may be generated by a same initial parameter but with a cyclic shift among different phase adjustment sequences, where the cyclic shift may be based on some (pre-) configuration, e.g., UE ID, or repetition index. The PAPR represents for the PAPR value in time domain. For frequency domain repetition signals, a phase adjustment vector with different cyclic shift value is multiplied with different repetitions. The cyclic shift phase adjustment vector is generated based on an initial phase vector (e.g., a ZC sequence vector, etc.). For example, in the case of the initial phase vector being a ZC sequence, the initial phase vector may be expressed as follows:

$$α ( n ) = {e}^{j \frac{π un ( n + 1 )}{L}} , n = 0 , 1 , … , L - 1$$

where u is the root index of the ZC sequence, n is the index of the initial phase vector (i.e., the ZC sequence), L is the length of the initial phase vector. The cyclic shift phase adjustment vector may be expressed as follows:

$${α}_{v} ( n ) = α ( ( n + {C}_{v} ) mod L ) , n = 0 , 1 , … , L - 1$$

where Cᵥ is the cyclic shift value for cyclic shift phase adjustment vector. For different repetitions of the frequency domain signal, the cyclic shift value for phase adjustment vector is set to different values. For example, a frequency domain signal S of length Lₛ is repeated for 2 times, and the repeated signal may be expressed as {S, S₁, S₂}. For signal S₁, the cyclic shift value Cᵥ for phase adjustment vector is set to K, where K is the length of resource elements in frequency domain of signal S per symbol. The length of the cyclic shift phase vector is L=Lₛ. The signal S₁ after multiplied with the cyclic shift phase adjustment vector may be expressed as {S₁(n)·α((n+K) mod L)}, n=0, 1, . . . , L−1. For signal S₂, the cyclic shift value Cᵥ for phase adjustment vector is set to 2K. The signal S₂ after multiplied with the cyclic shift phase adjustment vector may be expressed as {S₂(n)·α((n+2K) mod L)}, n=0, 1, . . . , L−1. The phase vector with different cyclic shift value Cᵥ may be multiplied with all repetitions or some of the repetitions, where the repetitions include or not include the original signal S.

### Illustrative Implementations

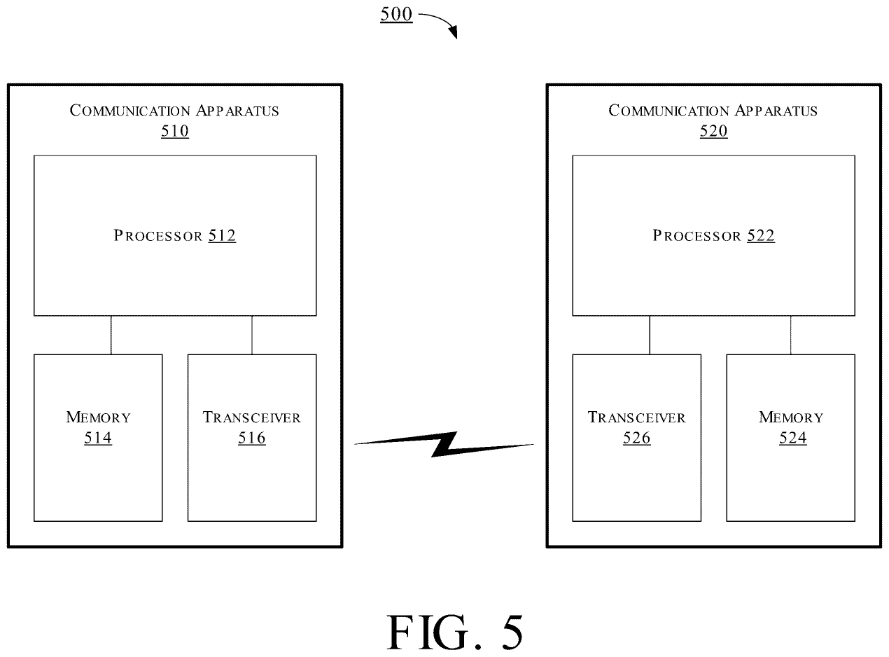

FIG. 5 illustrates an example communication system 500 having at least two communication apparatuses 510 and 520 in accordance with an implementation of the present disclosure. Each of communication apparatus 510 and communication apparatus 520 may perform various functions to implement schemes, techniques, processes and methods described herein pertaining to beam management and transmission enhancement in SL communication, including scenarios/schemes described above as well as processes 600, 700, and 800 described below.

Each of communication apparatus 510 and communication apparatus 520 may be a part of an electronic apparatus, which may be a UE, such as a portable or mobile apparatus, a wearable apparatus, a vehicular device or a vehicle, a wireless communication apparatus or a computing apparatus. For instance, each of communication apparatus 510 and communication apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of communication apparatus 510 and communication apparatus 520 may also be a part of a machine type apparatus, which may be an IoT/NB-IoT/IIot apparatus such as an immobile or a stationary apparatus, a home apparatus, a roadside unit (RSU), a wire communication apparatus or a computing apparatus. For instance, each of communication apparatus 510 and communication apparatus 520 may be implemented in a smart thermostat, a smart fridge, a smart door lock, a wireless speaker or a home control center.

In some implementations, each of communication apparatus 510 and communication apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of communication apparatus 510 and communication apparatus 520 may be implemented in or as a UE. Each of communication apparatus 510 and communication apparatus 520 may include at least some of those components shown in FIG. 5 such as a processor 512 and a processor 522, respectively, for example. Each of communication apparatus 510 and communication apparatus 520 may further include one or more other components not pertinent to the proposed scheme of the present disclosure (e.g., internal power supply, display device and/or user interface device), and, thus, such component(s) of communication apparatus 510 and communication apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to beam management and transmission enhancement in SL communication in accordance with various implementations of the present disclosure.

In some implementations, communication apparatus 510 may also include a transceiver 516 coupled to processor 512. Transceiver 516 may be capable of wirelessly transmitting and receiving data. In some implementations, transceiver 516 may be capable of wirelessly communicating with different types of UEs/wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, communication apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, communication apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 514 and memory 524 may include a universal integrated circuit card (UICC).

Each of communication apparatus 510 and communication apparatus 520 may be a communication entity capable of communicating with each other using various proposed schemes in accordance with the present disclosure. For illustrative purposes and without limitation, a description of capabilities of communication apparatus 510, as a UE (e.g., a Tx UE, an Announcing UE, or a Discoverer UE), and communication apparatus 520, as a peer UE (e.g., an Rx UE, a Monitoring UE, or a Discoveree UE), is provided below with processes 600, 700, and 800.

### Illustrative Processes

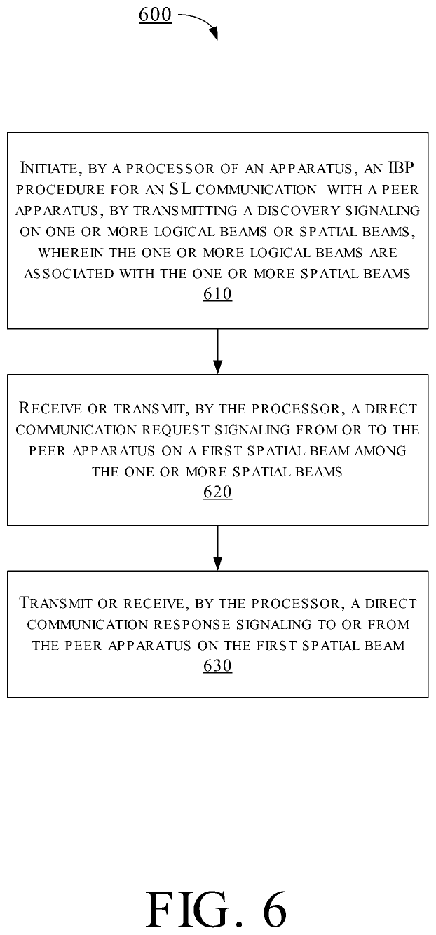

FIG. 6 illustrates an example process 600 under schemes in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to beam management in SL communication (e.g., in FR2). Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in communication apparatus 510 and communication apparatus 520 as well as any variations thereof. Solely for illustrative purposes and without limiting the scope, process 600 is described below in the context of communication apparatus 510 as a UE (e.g., a Tx UE, an Announcing UE, or a Discoverer UE) and communication apparatus 520 as a peer UE (e.g., an Rx UE, a Monitoring UE, or a Discoveree UE). Process 600 may begin at block 610.

At block 610, process 600 may involve processor 512 of communication apparatus 510, implemented in or as a UE, initiating an IBP procedure for an SL communication with communication apparatus 520, by transmitting a discovery signaling on one or more logical beams or spatial beams, wherein the one or more logical beams are associated with the one or more spatial beams. Process 600 may proceed from block 610 to block 620.

At block 620, process 600 may involve processor 512 receiving or transmitting, via transceiver 516, a direct communication request signaling from or to communication apparatus 520 on a first spatial beam among the one or more spatial beams. Process 600 may proceed from block 620 to block 630.

At block 630, process 600 may involve processor 512 transmitting or receiving, via transceiver 516, a direct communication response signaling to or from communication apparatus 520 on the first spatial beam.

In some implementations, process 600 may further involve processor 512 determining the IBP procedure being successful in an event that the direct communication response signaling includes a direct communication accept message. Additionally, process 600 may involve processor 512 performing the SL communication with the peer apparatus on the first spatial beam.

In some implementations, process 600 may further involve processor 512 determining the IBP procedure being failed in an event that the direct communication response signaling includes a direct communication reject message (or that no direct communication response signaling is received from communication apparatus 520). Additionally, process 600 may involve processor 512 restarting the IBP procedure for the SL communication with communication apparatus 520.

In some implementations, the discovery signaling may include a discovery announcement message.

In some implementations, process 600 may further involve processor 512 receiving, via transceiver 516, a discovery response message from communication apparatus 520 on the first spatial beam in an event that the discovery signaling includes a discovery solicitation message.

In some implementations, the discovery signaling may be repeatedly transmitted on the first spatial beam or a first logical beam associated with the first spatial beam, or may be repeatedly transmitted on the logical beams or the spatial beams in a beam sweeping manner.

In some implementations, the direct communication request signaling may be received or transmitted based on a configuration of one or more candidate time resources, and the configuration may be previously indicated to communication apparatus 520 by communication apparatus 510 or may be preconfigured.

In some implementations, the discovery signaling may be transmitted with an RS including a standalone RS or a non-standalone RS, or may be transmitted separately from the RS. Additionally, the standalone RS may be generated based on at least one of a first L2 or L1 ID associated with communication apparatus 510 and a second L2 or L1 ID associated with communication apparatus 520, or the standalone RS or the non-standalone RS may be generated based on a unique UE ID of communication apparatus 510.

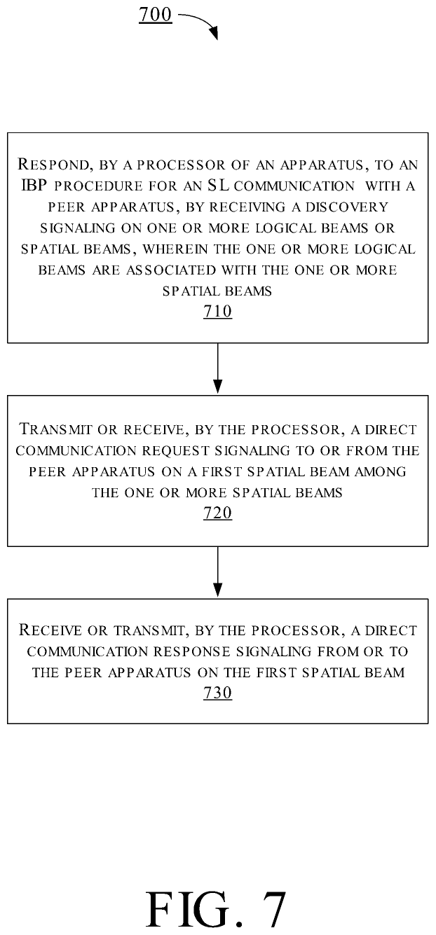

FIG. 7 illustrates an example process 700 under schemes in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to beam management in SL communication (e.g., in FR2). Process 700 may include one or more operations, actions, or functions as illustrated by one or more of blocks 710, 720, and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in communication apparatus 510 and communication apparatus 520 as well as any variations thereof. Solely for illustrative purposes and without limiting the scope, process 700 is described below in the context of communication apparatus 520 as a UE (e.g., an Rx UE, a Monitoring UE, or a Discoveree UE) and communication apparatus 510 as a peer UE (e.g., a Tx UE, an Announcing UE, or a Discoverer UE). Process 700 may begin at block 710.

At block 710, process 700 may involve processor 522 of communication apparatus 520, implemented in or as a UE, responding to an IBP procedure for an SL communication with communication apparatus 510, by receiving a discovery signaling on one or more logical beams or spatial beams, wherein the one or more logical beams are associated with the one or more spatial beams. Process 700 may proceed from block 710 to block 720.

At block 720, process 700 may involve processor 522 transmitting or receiving, via transceiver 526, a direct communication request signaling to or from communication apparatus 510 on a first spatial beam among the one or more spatial beams. Process 700 may proceed from block 720 to block 730.

At block 730, process 700 may involve processor 522 receiving or transmitting, via transceiver 526, a direct communication response signaling from or to communication apparatus 510 on the first spatial beam.

In some implementations, process 700 may further involve processor 522 determining the IBP procedure being successful in an event that the direct communication response signaling includes a direct communication accept message. Additionally, process 700 may involve processor 522 performing the SL communication with communication apparatus 510 on the first spatial beam.

In some implementations, process 700 may further involve processor 522 determining the IBP procedure being failed in an event that the direct communication response signaling includes a direct communication reject message (or that no direct communication response signaling is received from communication apparatus 510).

In some implementations, the discovery signaling may include a discovery announcement message.

In some implementations, process 700 may further involve processor 522 transmitting, via transceiver 526, a discovery response signaling to communication apparatus 510 on the first spatial beam in an event that the discovery signaling includes a discovery solicitation message.

In some implementations, the direct communication request signaling may be transmitted or received based on a configuration of one or more candidate time resources, and the configuration may be previously indicated by communication apparatus 510 or may be preconfigured.

In some implementations, the discovery signaling may be received with an RS including a standalone RS or a non-standalone RS, or may be received separately from the RS. Additionally, the standalone RS may be generated based on at least one of a first L2 or L1 ID associated with communication apparatus 510 and a second L2 or L1 ID associated with communication apparatus 520, or the standalone RS or the non-standalone RS may be generated based on a unique UE ID of communication apparatus 510.

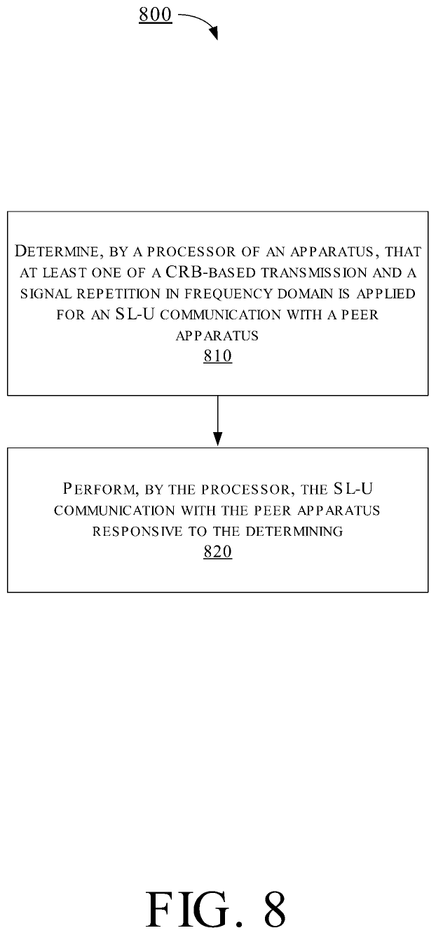

FIG. 8 illustrates an example process 800 under schemes in accordance with an implementation of the present disclosure. Process 800 may represent an aspect of implementing various proposed designs, concepts, schemes, systems and methods described above, whether partially or entirely, including those described above. More specifically, process 800 may represent an aspect of the proposed concepts and schemes pertaining to transmission enhancement in SL-U communication. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. Furthermore, one or more of the blocks/sub-blocks of process 800 may be executed iteratively. Process 800 may be implemented by or in communication apparatus 510 and communication apparatus 520 as well as any variations thereof. Solely for illustrative purposes and without limiting the scope, process 800 is described below in the context of communication apparatus 510 as a UE (e.g., a Tx UE) and communication apparatus 520 as a peer UE (e.g., an Rx UE). Process 800 may begin at block 810.

At block 810, process 800 may involve processor 512 of communication apparatus 510, implemented in or as a UE, determining that at least one of a CRB-based transmission and a signal repetition in frequency domain is applied for an SL-U communication with communication apparatus 520. Process 800 may proceed from block 810 to block 820.

At block 820, process 800 may involve processor 512 performing the SL-U communication with communication apparatus 520 responsive to the determining.

In some implementations, the CRB-based transmission may include: using intra-cell GB PRBs between two adjacent RB sets for PSSCH transmission, in an event that communication apparatus 510 has successfully performed a channel access procedure in both of the two adjacent RB sets and communication apparatus 510 uses both of the two adjacent RB sets for PSSCH transmission.

In some implementations, the CRB-based transmission may include: determining not to use candidate resources, corresponding to a number of contiguous sub-channels in which a sub-channel with a smallest index includes RBs of the intra-cell GB PRBs, for PSSCH transmission.

In some implementations, the CRB-based transmission may include: determining to use candidate resources, corresponding to a number of contiguous sub-channels in which at least a first sub-channel has a smaller index than that of a second sub-channel including RBs of the intra-cell GB PRBs, for PSSCH transmission.

In some implementations, the signal repetition in frequency domain may include: applying a phase adjustment vector with different cyclic shift values for different repetitions of a signal in frequency domain, wherein the phase adjustment vector is generated based on an initial phase vector and the cyclic shift values are set to be different values.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
initiating, by a processor of an apparatus, an initial beam pairing (IBP) procedure for a sidelink (SL) communication with a peer apparatus, by transmitting a discovery signaling on one or more logical beams or spatial beams, wherein the one or more logical beams are associated with the one or more spatial beams;
receiving or transmitting, by the processor, a direct communication request signaling from or to the peer apparatus on a first spatial beam among the one or more spatial beams; and
transmitting or receiving, by the processor, a direct communication response signaling to or from the peer apparatus on the first spatial beam.

2. The method of claim 1, further comprising:
determining, by the processor, the IBP procedure being successful in an event that the direct communication response signaling comprises a direct communication accept message; and
performing, by the processor, the SL communication with the peer apparatus on the first spatial beam.

3. The method of claim 1, further comprising:
determining, by the processor, the IBP procedure being failed in an event that the direct communication response signaling comprises a direct communication reject message; and
restarting, by the processor, the IBP procedure for the SL communication with the peer apparatus.

4. The method of claim 1, wherein the discovery signaling comprises a discovery announcement message.

5. The method of claim 1, further comprising:
receiving, by the apparatus, a discovery response message from the peer apparatus on the first spatial beam in an event that the discovery signaling comprises a discovery solicitation message.

6. The method of claim 1, wherein the discovery signaling is repeatedly transmitted on the first spatial beam or a first logical beam associated with the first spatial beam, or is repeatedly transmitted on the logical beams or the spatial beams in a beam sweeping manner.

7. The method of claim 1, wherein the direct communication request signaling is received or transmitted based on a configuration of one or more candidate time resources, and the configuration is previously indicated to the peer apparatus by the apparatus or is preconfigured.

8. The method of claim 1, wherein the discovery signaling is transmitted with a reference signal (RS) comprising a standalone RS or a non-standalone RS, or is transmitted separately from the RS, and
the standalone RS is generated based on at least one of a first layer-2 (L2) or layer-1 (L1) identifier (ID) associated with the apparatus and a second L2 or L1 ID associated with the peer apparatus; or
the standalone RS or the non-standalone RS is generated based on a unique user equipment (UE) ID of the apparatus.

9. A method, comprising:
responding, by a processor of an apparatus, to an initial beam pairing (IBP) procedure for a sidelink (SL) communication with a peer apparatus, by receiving a discovery signaling on one or more logical beams or spatial beams, wherein the one or more logical beams are associated with the one or more spatial beams;
transmitting or receiving, by the processor, a direct communication request signaling to or from the peer apparatus on a first spatial beam among the one or more spatial beams; and
receiving or transmitting, by the processor, a direct communication response signaling from or to the peer apparatus on the first spatial beam.

10. The method of claim 9, further comprising:
determining, by the processor, the IBP procedure being successful in an event that the direct communication response signaling comprises a direct communication accept message; and
performing, by the processor, the SL communication with the peer apparatus on the first spatial beam.

11. The method of claim 9, further comprising:
determining, by the processor, the IBP procedure being failed in an event that the direct communication response signaling comprises a direct communication reject message.

12. The method of claim 9, wherein the discovery signaling comprises a discovery announcement message.

13. The method of claim 9, further comprising:
transmitting, by the apparatus, a discovery response signaling to the peer apparatus on the first spatial beam in an event that the discovery signaling comprises a discovery solicitation message.

14. The method of claim 9, wherein the direct communication request signaling is transmitted or received based on a configuration of one or more candidate time resources, and the configuration is previously indicated by the peer apparatus or is preconfigured.

15. The method of claim 9, wherein the discovery signaling is received with a reference signal (RS) comprising a standalone RS or a non-standalone RS, or is received separately from the RS, and
the standalone RS is generated based on at least one of a first layer-2 (L2) or layer-1 (L1) identifier (ID) associated with the peer apparatus and a second L2 or L1 ID associated with the apparatus; or
the standalone RS or the non-standalone RS is generated based on a unique user equipment (UE) ID of the peer apparatus.

16. A method, comprising:
determining, by a processor of an apparatus, that at least one of a contiguous resource block (CRB)-based transmission and a signal repetition in frequency domain is applied for a sidelink (SL) over unlicensed spectrum (SL-U) communication with a peer apparatus; and
performing, by the processor, the SL-U communication with the peer apparatus responsive to the determining.

17. The method of claim 16, wherein the CRB-based transmission comprises:
using intra-cell guard band (GB) physical resource blocks (PRBs) between two adjacent RB sets for physical sidelink shared channel (PSSCH) transmission, in an event that the apparatus has successfully performed a channel access procedure in both of the two adjacent RB sets and the apparatus uses both of the two adjacent RB sets for PSSCH transmission.

18. The method of claim 16, wherein the CRB-based transmission comprises:
determining not to use candidate resources, corresponding to a number of contiguous sub-channels in which a sub-channel with a smallest index comprises RBs of the intra-cell GB PRBs, for PSSCH transmission.

19. The method of claim 18, wherein the CRB-based transmission comprises:
determining to use candidate resources, corresponding to a number of contiguous sub-channels in which at least a first sub-channel has a smaller index than that of a second sub-channel comprising RBs of the intra-cell GB PRBs, for PSSCH transmission.

20. The method of claim 16, wherein the signal repetition in frequency domain comprises:
applying a phase adjustment vector with different cyclic shift values for different repetitions of a signal in frequency domain, wherein the phase adjustment vector is generated based on an initial phase vector and the cyclic shift values are set to be different values.
